(19) United States
(12) Patent Application Publication
(10) Pub. No.: US 2024/0075749 A1
(43) Pub. Date: Mar. 7, 2024

(54) INK SUPPLY SYSTEM AND INK SUPPLY METHOD FOR DIGITAL PRINTING

(71) Applicant: Dekron GmbH, Kelkheim (DE)

(72) Inventor: Sven KERPE, Linkenheim-Hochstetten (DE)

(21) Appl. No.: 18/454,633

(22) Filed: Aug. 23, 2023

(30) Foreign Application Priority Data
Sep. 2, 2022 (DE) 10 2022 122 252.7

(51) Int. Cl. B41J 2/18; B41J 2/175; B41J 3/407

(52) U.S. Cl. CPC B41J 2/18; B41J 2/17563; B41J 2/17566; B41J 3/4073

(57) ABSTRACT

The disclosure relates to an ink supply system for use in a device for printing on articles, in particular containers, with ink, comprising: one or more recirculating ink supply devices, each comprising at least one print head, a pressurized feed tank coupled to an input of the print head for supplying ink to the print head, a pressurized return tank coupled to an output of the print head for removal of ink not consumed by the print head, wherein the return tank is coupled to the feed tank, and wherein the ink supply system comprises a central feed pressure unit and a central return pressure unit, and wherein at least one ink supply device is coupled to the central feed pressure unit and to the central return pressure unit such that the pressure in the feed tank of the at least one ink supply device is provided by the central feed pressure unit and the pressure in the return tank of the at least one ink supply device is provided by the central return pressure unit.

### CROSS REFERENCE TO RELATED APPLICATION

The present application claims priority to German Patent Application No. 10 2022 122 252.7 filed on Sep. 2, 2022. The entire contents of the above-listed application are hereby incorporated by reference for all purposes.

### BACKGROUND

The disclosure relates to an ink supply system for digital printing, in particular an ink supply system for use in a device for printing on articles, in particular containers, with ink, and a method for the ink supply during digital printing or a method for operating an ink supply system.

Inkjet printing systems are frequently used for printing on articles in the food and beverage industry.

The industrial inkjet printing systems used here are not comparable to conventional tabletop or office printers in terms of their size and their structure, not least due to their unequal consumption of ink quantities.

Ink supply to food and beverage printing systems is therefore an important component of such printing systems.

However, the disadvantage of known ink supply systems is, inter alia, their complex design and their susceptibility to faults, which can lead to frequent failures and long downtimes, for example caused by the ink that has escaped. In known ink supply systems, undesirable pressure fluctuations and ink flow fluctuations can also occur in the conduits thereof and can have a disadvantageous effect on the print quality.

### SUMMARY

### Object

It is therefore an object of the disclosure to improve an ink supply system for use in a device for printing on articles of the food and beverage industry.

In particular, it is an object of the disclosure to improve the efficiency, cost-effectiveness, robustness and susceptibility to failure of an ink supply system for printing systems of the food and beverage industry.

However, it is also conceivable to use the ink supply system in other industrial sectors, for example for printing on articles in the healthcare sector or in the pharmaceutical industry.

### Achievement

This is achieved according to the disclosure by an ink supply system and a method for operating an ink supply system as described herein.

For example, an ink supply system described herein for digital printing or the printing on articles or for use in a device for printing on articles, in particular containers, with ink, can comprise one or more, e.g., at least two, recirculating ink supply devices.

Each ink supply device of said ink supply devices can comprise the following one, some or all of the following components:
at least one print head,
a pressurized feed tank coupled to an input of the print head for supplying ink to the print head,
a pressurized return tank coupled to an output of the print head for removing ink not consumed by the print head, and wherein the return tank is coupled to the feed tank.

Said exemplary print head may have a plurality of nozzles through which ink drops can be expelled.

An ink flow can be applied or provided to the print head via the pressurized feed tank, which is at least partially filled with ink.

The term “recirculating ink supply device” is to be understood in particular to mean that ink which was not consumed or not printed by the print head can be discharged to a return tank whence it can be fed back to the feed tank and can be conducted again from the feed tank to the print head.

The ink flow/the ink stream can thus circulate through the components of the ink supply device, wherein used or printed ink can be fed from an ink refilling reservoir of the ink supply device.

In other words, a recirculating ink supply device described herein is not a so-called “dead-end shooter.”

The term ink may, inter alia, also be understood herein as a printing fluid or a liquid printing medium in general. Some examples of possible inks may include ultraviolet (UV) ink, solvent-based ink, latex ink, digitally printable primer, or high-viscosity ink for Braille or embossing printing.

The term “pressure” can be understood herein to mean, in particular, a gas pressure or the pressure of a gas volume or an ink pressure or a hydrostatic pressure.

Said ink supply system can additionally comprise a central feed pressure unit, in particular exactly one, and a central return pressure unit, in particular exactly one.

From said ink supply device, at least one ink supply device can be coupled to the central feed pressure unit and to the central return pressure unit such that the pressure in the feed tank of the at least one ink supply device is provided by the central feed pressure unit and the pressure in the return tank of the at least one ink supply device is provided by the central return pressure unit.

The coupling of said components of the ink supply system to guide the ink/ink flow or to pressurize between the components of the ink supply system or between the components of the ink supply device(s) can be accomplished via hose-like and or tube-like conduits/connections.

The ink supply system can thus have a hose and/or tubing system for guiding the ink/the ink flow between the components of the ink supply system or for the transfer of gas pressures and ink pressures.

The pressure provided by the central feed pressure unit may be a constant pressure that is not equal to the atmospheric pressure prevailing in the working environment of the ink supply system.

The pressure provided by the central return pressure unit may also be a constant gas pressure that is not equal to the atmospheric pressure prevailing in the working environment of the ink supply system.

The pressure/constant pressure provided by the central feed pressure unit can be different from the pressure/constant pressure provided by the central return pressure unit.

The gas provided by the central return pressure unit and by the central feed pressure unit can be air, for example.

In particular, the pressure/constant pressure provided by the central feed pressure unit can be greater than/higher than the pressure/constant pressure provided by the central return pressure unit.

The ink supply system described above and hereinafter further by way of example simplifies the construction of ink supply systems because it makes it possible to dispense with complicated pressure regulation units that are susceptible to faults on the feed tanks and the return tanks of ink supply devices. In particular, individual pressure regulation units and ones directly mounted on the feed tanks or the return tanks can be dispensed with.

The aforesaid central feed pressure unit and said central return pressure unit can be arranged spatially remotely separated from the other components, such as the print heads or the feed tanks or the return tanks, at positions where installation space conditions are less limited. This can contribute to an optimized and improved use of installation space.

For example, if necessary, the distances or the spacing between said central feed pressure unit or between said central return pressure unit and the other components, such as the feed tanks or the return tanks, can be several meters or even more.

For example, the feed tanks and/or the return tanks can be arranged at least partially or completely below the print heads or below sensitive components, such as the electronics of a controller, so that, in the event of a leakage of ink from the feed tanks or return tanks, no sensitive components are soiled or damaged with ink.

The ink supply system described by way of example here is also easily scalable by the central arrangement of the central feed pressure unit and the central return pressure unit, i.e., the ink supply system can comprise any number of recirculating ink supply devices.

For example, the ink supply system described by way of example here can have a plurality of recirculating ink supply devices, wherein the feed tanks of a plurality of the ink supply devices or the feed tanks of all ink supply devices are coupled to the central feed pressure unit, and wherein the central feed pressure unit provides a pressure, in particular in each case a constant pressure or respectively the same pressure, for the feed tanks of the ink supply devices coupled to the central feed pressure unit.

Alternatively or additionally, the return tanks of a plurality of the ink supply devices of the plurality of recirculating ink supply devices of the ink supply system or the return tanks of all ink supply devices of the ink supply system can be coupled to the central return pressure unit.

The central return pressure unit can in each case provide a pressure, in particular in each case a constant pressure or in each case the same pressure, for the return tanks of the ink supply devices coupled to the central return pressure unit.

The central feed pressure unit can thus provide a constant first gas pressure for the feed tanks of all ink supply devices, or for the feed tanks coupled to the central feed pressure unit, and the central return pressure unit can provide a constant second gas pressure for the return tanks of all ink supply devices, or for the return tanks coupled to the central return pressure unit.

The first pressure provided by way of example or the constant first pressure provided by way of example by the central feed pressure unit and the second pressure provided by way of example or the constant second pressure provided by way of example by the central return pressure unit can be different from one another.

In the case of an ink supply device coupled to the central feed pressure unit and to the central return pressure unit, the pressure in the feed tank of the ink supply device can therefore differ from the pressure in the return tank of the ink supply device.

In particular, the pressure in the feed tank of the ink supply device can be greater than/higher than the pressure in the return tank of the ink supply device.

The term “feed” of an ink supply device can be understood in particular as the volume between the print head or a print head nozzle plane of the print head, and the ink level in the feed tank of the ink supply device.

The term “return” of an ink supply device can be understood in particular as the volume between the print head or a print head nozzle plane of the print head, and the ink level in the return tank of the ink supply device.

Exemplary pressure values or pressure value ranges in the feed or in the return of the/a respective ink supply device, for example at the height of the print head nozzle plane, can be between 0 and +/−200 mbar, for example.

For example, if the feed and return tank with the ink levels in the feed and return tank are placed at the level of the print head nozzle planes of the print head, the feed pressure/return pressure at the level of the print head nozzle plane may be equal to the pressure of the central feed pressure vessel/return pressure vessel.

These pressure values or pressure value ranges may also depend on the height placement of the feed tanks and return tanks relative to the height placement of the print head/print head nozzle plane.

If, for example, the feed tanks and return tanks are placed lower than the print head and, for example, the feed and return tanks are located with the ink levels in the tanks 500 mm below the print head, for example below a nozzle plate of the print head, the following exemplary changes in the pressures may result.

The feed pressure range can change, for example, from 0 to 200 mbar to 50 to 250 mbar, and the return pressure range can change from 0 to −200 mbar to 50 to −150 mbar, wherein a height change of 1 cm can correspond to a pressure change of approximately 1 mbar.

If, for example, the pressure prevailing in the feed is 70 mbar and in the return −120 mbar, this can change to a feed pressure of 120 mbar and a return pressure of −70 mbar via said exemplary height change.

The ink supply system described by way of example herein is characterized by a simplified pressure regulation and thus saves on costs.

The central provision of the pressure for the feed tanks and the return tanks through the central feed pressure unit and the central return pressure unit also do not have a negative effect on the regulation, because the pressure at sonic velocity spreads out, and thus large distances are possible between the feed tanks and the central feed pressure unit, as well as between return tanks and the central return pressure unit.

Since almost no mass flow goes through the hose lines or tubing via which the components of the ink supply system can be coupled, the flow loss can also be disregarded.

By means of the central feed pressure unit and the central return pressure unit, individual pressure control units are no longer needed on the respective feed tanks or on the respective return tanks of the respective ink supply devices, which keeps the number of pressure control units equal to zero or as low as possible even in the case of a plurality of the ink supply devices, and thereby saves considerable costs.

If, moreover, the overflow of ink into the feed tanks and/or the return tanks should occur, the ink or foam may that may have formed in the ink can be received in the hose or tubing system of the ink supply system, as a result of which no damage to the printing system or the pressure integrity of the ink supply system can occur as may be the case, for example, in known pressure control units which are integrated into the ink supply.

The volume of the central feed pressure unit can moreover be greater, in particular can be a multiple greater than the volume of the respective feed tanks of the ink supply devices which are coupled to the central feed pressure unit.

Likewise, the volume of the central return pressure unit can be greater, in particular can be a multiple greater, than the volume of the respective return tanks of the ink supply devices which are coupled to the central return pressure unit.

The central feed pressure unit and the central return pressure unit thus also provide a large buffer volume for catching undesired pressure fluctuations in the ink supply system.

In contrast to the prior art, a much larger volume is available because not only the volume between the ink level and the residual volume of the feed or return tank, but also the hose and/or tubing system and the central pressure vessels, i.e., the central feed pressure unit and the central return pressure unit of the ink supply system, determine the available volume.

With an exemplary number of approximately two to ten ink supply devices, the volume of the central feed pressure unit or the volume of the central return pressure unit can, for example, be 1000 ml to 2000 ml or more.

With a number of more than ten ink supply devices, the volume of the central feed pressure unit or the volume of the central return pressure unit can be, for example, 2000 ml to 10,000 ml or more.

It can thus be ensured, inter alia, that a sufficiently large buffer volume is available for catching undesired pressure fluctuations in the ink supply system, wherein the buffer volume can be formed, for example, between the ink level of the respective tank and the remaining gas volume of the respective tanks including the volume of the central pressure vessel and the volume of the hose and/or tubing system.

This buffer volume, which is larger than known systems, not only contributes to the simplification of the pressure regulation, but also reduces pressure fluctuations in the print heads of the ink supply devices. The improved stability of the pressure conditions in the print heads leads to a more uniform ink drop formation in the print heads and thus to a more uniform and more precise print image. A better color fidelity can also be achieved by smaller deviations in the droplet volume.

The ink supply system described herein is therefore also characterized by an improved print quality compared to known systems.

The ink supply system described herein can further comprise means, for example suction means and/or pumping means or pumps, for regulating the height of the ink level in the feed tank and/or in the return tank of the respective ink supply device.

The ink level can be understood here as the ink fill level.

The regulation of the height of the ink level in the feed tank and/or of the ink level in the return tank of the respective ink supply device(s) can be carried out completely independently of the regulation of the pressure in the feed tank and/or independently of the regulation of the pressure in the return tank.

In other words, the ink supply system can have a control circuit for regulating the ink level in the feed tank and the ink level in the return tank of the respective ink supply device, as well as an independent further control loop for regulating the pressure in the feed tank and for regulating the pressure in the return tank of the respective ink supply device(s).

By regulating the height of the ink level in the feed tank and/or in the return tank, the meniscus pressure in the print head of the respective ink supply device can be changed or regulated.

The meniscus pressure can be understood herein to mean the pressure prevailing in the print head, in particular the nominal pressure or the pressure applied to the nozzles or to the pressure openings of the print head.

The meniscus pressure influences the quality of the ink drop formation during printing.

If, for example, printing is not occurring, the meniscus pressure is optionally negative, or optionally a vacuum, in order to be able to avoid undesired escape of ink from the print head.

For the change of the meniscus pressure, for example, the ink level in the feed tank and in the return tank can be increased, whereby a reduction of the meniscus pressure in the respective print head can take place.

In order to bring about an increase in the meniscus pressure in the respective print head, the ink level in the feed tank and in the return tank can be lowered,

In this way, the meniscus pressure can be adjusted without the pressure in the feed tank or the pressure in the return tank changing.

The meniscus pressure can be changed solely on the basis of the changed hydrostatic pressures by the ink.

The level of the ink column relative to the ink level for the respective print head can be used as a decisive parameter for the calculation of the regulation of the ink level in the respective feed tanks and return tanks for the meniscus pressure change.

The height of the ink column can be understood as the vertical distance between the print head, e.g., a/the nozzle plate of the print head, against which a certain meniscus pressure is to be applied and the ink level in the respective feed or return tank.

The level of this ink column results in a hydrostatic pressure which behaves linearly with respect to the height. Here, 1 mbar corresponds to about 1 cm.

By changing the height of the ink column, in that the ink level is changed in the respective tank, the hydrostatic pressure can change, as a result of which the total pressure is also changed which results from the pressure of the respective central pressure supply unit(s) and the respective hydrostatic pressure.

The total pressure can be decisive for the meniscus pressure and the differential pressure.

The regulation of the height of the ink level in the feed tank and/or in the return tank can also cause a change in the pressure difference between the pressure in the feed and the pressure in the return of the respective ink supply device.

By means of a regulation or a change in the pressure difference between the pressure in the feed and the pressure in the return of the respective ink supply device, the delivery rate or flow rate of ink can be regulated or controlled by the respective ink supply device.

To change the pressure difference between the feed and return flow, the ink level in the feed tank can be increased, for example, via pumping or suction means, while the ink level in the return tank can be reduced.

Alternatively, the ink level in the feed tank can be reduced for changing the pressure difference between the feed and the return flow, for example via pumping or suction means, while the ink level in the return tank can be increased.

The exemplary pumping or suction means can be arranged, for example, between the feed tank and the return tank of the respective ink supply device.

The exemplary pump or suction means can also ensure constant ink levels in the tanks.

If the ink level in the feed tank is increased, the level in the return tank decreases. A change in the meniscus pressure does not occur here. Only an increase of the differential pressure is brought about, thereby enabling an adjustment of the flow rate of ink when required.

If the level in the feed tank is reduced, the level in the return tank is increased. A change in the meniscus pressure also does not occur here. Only a reduction of the differential pressure is brought about, thereby enabling an adjustment of the flow rate of ink when required.

By changing the differential pressure, an individual adaptation of the pressure or total pressure in the respective ink supply can be achieved, wherein the pressure or total pressure in the respective ink supply is composed of the gas pressure and the hydrostatic pressure in the respective ink supply. The constant pressure provided by the central printing units does not change, however.

For the sake of completeness, it should be noted that the return tanks and/or the feed tanks can also be height-adjustable, so that alternatively or additionally the ink level in the return tanks and/or the feed tanks or the hydrostatic ink pressure can be influenced or changed or regulated via a height change of the return tanks and/or the feed tanks.

The ink supply devices of the ink supply system may further comprise heating means for heating the bottoms and/or the side walls of the feed tank and/or of the return tank of the respective ink supply device.

The hose and/or tubing system of the ink supply devices of the ink supply system can also have heating means, in particular in the vicinity of the feed to the print head.

The heating means can be designed as preheating in the feed or return tanks, as a total heating in the feed or return tanks or as a combination with preheating in the feed or return tanks and/or hose heating in the print head or as preheating in the feed or return tanks and heating in the print head

Possible heating means may comprise heating coils and/or heating rods and/or heating mats.

The heating means can serve for temperature control or heating of the ink in order to optimize the flow properties of the ink. For example, jetting or expelling the droplets can be determined by the viscosity of the ink. The optimal viscosity can then be ensured by a uniform temperature control of the ink via the heating means.

In order to avoid influences due to the ambient temperature, an ink temperature can also be set which may be greater than the maximum ambient temperature.

The side walls of the feed tanks and/or the return tanks of the respective ink supply device can have a wall thickness of more than 2 mm or more than 10 mm or more than 20 mm.

The sidewalls of the feed tanks can thus serve as heat buffers to maintain the ink at an optimized temperature for optimal flow properties.

The height of the side walls of the feed tanks and/or of the return tanks of the respective ink supply device can be greater than the maximum extension of the bottom surface of the feed tanks and/or of the return tanks.

The geometry of the feed tanks and/or of the return tanks offers numerous advantages. Relatively small base areas in the feed or return tank enable a faster change of the ink level because the necessary volume of ink to be moved for the change is smaller.

Furthermore, the ratio between the wall area of the tanks and the ink volume is greater, whereby a larger wall surface per unit volume is available for the heat transfer of heating means.

The ink supply devices can also each have an ink filter, wherein the ink filter can be arranged between the return tank and the feed tank of the respective ink supply device.

The optional ink filter can filter out unwanted foreign particles in the ink. Such unwanted foreign particles can, for example, get into the return tank during an ink refilling. By means of the ink filter, it can be avoided, for example, in particular that said unwanted foreign particles get into the print head and damage or clog it.

As a result of this arrangement, changes in the flow resistance in the ink circuit region from the feed tank to the return tank which would require an individual adaptation of the meniscus pressure in the respective ink system can be avoided.

If the filter were located between the feed tank and the print head or between the print head and return tank, a change in the flow resistance in or through the filter would result in a change in the meniscus pressure and the differential pressure.

This can be avoided by arranging the filter between return tank and feed tank

As already mentioned, a pumping means, for example a pump, can be located between the return tank and the feed tank of a respective ink supply device, which pump can pump ink out of the return tank into the feed tank.

When the filter is used, this pump can be controlled in such a way that the ink levels in the feed tank and in the return tank remain the same, i.e., the amount of ink conveyed by the pump can correspond to the amount of ink discharged from the feed.

The amount withdrawn during the printing process can otherwise be refilled by a refill system into the return tank in order to keep the ink level constant.

The respective return tanks and/or the respective feed tanks of the ink supply devices of the ink supply system described by way of example herein can also have stirrers.

These stirrers can prevent undesired sedimentation of the ink in the respective return tanks and/or in the respective feed tanks of the ink supply devices and ensure that the ink in the tanks maintains its optimal consistency and its optimal flow properties.

The ink supply system described by way of example herein or the ink supply devices of the ink supply system can each have sensors, for example ultrasonic sensors, for measuring the ink level in the respective return tanks and/or in the respective feed tanks.

Alternatively or additionally, the ink supply devices can each have sensors for measuring the temperature of the ink in the respective return tanks and/or in the respective feed tanks.

Alternatively or additionally, the ink supply devices can each have sensors for measuring the pressures in the respective return tanks and/or in the respective feed tanks and/or in or on the respective print heads.

Said possible exemplary sensors can provide their measurement data to at least one controller.

Said at least one controller can be a digital controller, i.e., have one or more processors, wherein the controller can evaluate the measurement data of the exemplary sensors and can control the ink supply system and all its components on the basis of the measurement data and/or on the basis of its programming.

Said exemplary digital controller may, among other things, be configured to control pressurization of the feed tanks of the ink supply devices via the central feed pressure unit and/or pressurization of the return tanks via the central return pressure unit via the central return pressure unit.

The controller can thus control the pressurization and pressure distribution in the ink supply system.

Moreover, the digital controller may be configured to control the means for regulating the level of the ink level in the feed tanks and/or in the return tanks of the ink supply devices.

Regardless of the control of the pressurization and pressure distribution in the ink supply system, the control can thus also control the ink level in the respective feed tanks and/or in the return tanks of the ink supply devices.

Thus, as described above, the controller can control both the meniscus pressure in the print heads of the respective ink supply devices and changes in the differential pressure between the various gas pressures in the feed tanks and the return tanks of the respective ink supply devices.

An exemplary method for supplying ink during the printing on articles, in particular containers, with ink, or an exemplary method for operating an ink supply system with one or more recirculating ink supply devices, wherein the ink supply system or the ink supply devices can have some or all of the features described above, can comprise the following steps.

Conveying ink from a feed tank of an ink supply device of the ink supply system to a print head of the respective ink supply device and conveying ink not consumed by the print head to a return tank of the respective ink supply device.

In this case, the conveying of the ink can be brought about by a pressure difference between a pressure in the feed and a pressure in the return flow, wherein the pressure in the feed tank of the respective ink supply device can be supplied/provided by a central feed pressure unit and the pressure in the return tank of the respective ink supply device can be supplied/provided by a central return pressure unit.

Said central feed pressure unit can provide a constant first gas pressure for the feed tanks of all ink supply devices, and the central return pressure unit can provide a constant second gas pressure for the return tanks of all ink supply devices, wherein the constant first gas pressure and the constant second gas pressure may be different from one another.

The meniscus pressure in the print head of the respective ink supply device can be regulated via an adjustment of the ink level in the feed tank and in the return tank of the respective ink supply device, wherein an increase in the ink level in the feed tank and in the return tank can cause a reduction of the meniscus pressure, and wherein a reduction of the ink level in the feed tank and in the return tank can cause an increase in the meniscus pressure.

A regulation or change of the differential pressure of the ink between the feed and the return of the respective ink supply device can take place via an adaptation of the ink level in the feed tank and in the return tank of the respective ink supply device, wherein the ink level in the feed tank is increased while the ink level in the return tank is reduced, or wherein the ink level in the feed tank is reduced while the ink level in the return tank is increased.

The ink supply system or the respective ink supply devices can also have at least one purge valve, for example a pneumatic valve, by means of which the connection between the print head and the return tank can be closed and thus a correspondingly high positive meniscus pressure can be built up. Positive meniscus pressure enables the ink to be pressed out of the print head nozzles in order to clean them.

In this case, exemplary steps can be carried out and controlled by said at least one controller, in particular by a digital controller, of the ink supply system.

The ink supply system described herein and the method steps described herein in the case of ink supply for printing on articles in the food and beverage industry offer, among other things, particular advantages over the known systems and methods:

The central pressurization of the feed tanks and return tanks allows the omission of complex individual pressure control units. Other components, such as valves and/or pumps, can also be dispensed with. Costs can hereby be saved.

By eliminating components which are no longer required, such as valves and/or pumps and/or individual pressure control units, installation space can be saved and the ink supply system can be designed more compactly. The elimination of components also increases the robustness of the ink supply system and reduces its susceptibility to faults.

The ink supply system is easily scalable and can be expanded to any number of recirculating ink supply devices.

Ink supply devices that are spatially separated from one another can also be pressurized by the central feed pressure unit and the central return pressure unit.

Simplified passive pressure regulation of the ink supply system, because a large volume is provided which can serve as a buffer. By providing constant gas pressures through the central feed pressure unit and the central return pressure unit, no active regulation of the gas pressure is necessary. If there is active regulation of the gas pressure, the volume must be small, because otherwise a pressure adjustment would be necessary for the system.

Improved pressure quality and lower contamination due to constant pressure regulation. Both the droplet formation and the satellites and ink mist formation are dependent on the pressures. More constant drop volume and more constant drop velocity ensure a more exact placement of the droplets on the substrate and better color rendering and thus an improvement in the print quality.

### BRIEF DESCRIPTION OF THE FIGURES

Further exemplary aspects of the disclosure are illustrated by way of example by the following figures.

FIG. 1: Exemplary ink supply device

FIG. 2: Exemplary ink supply system

FIG. 3: Exemplary ink level

### DETAILED DESCRIPTION

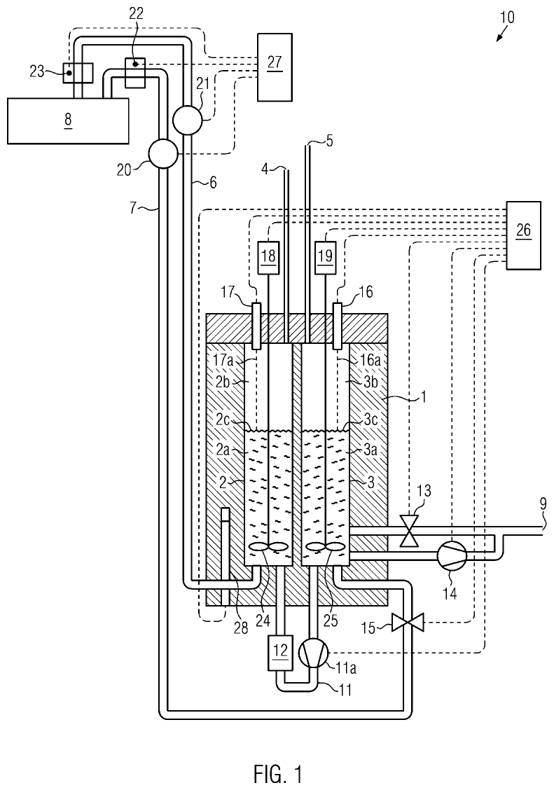

FIG. 1 represents by way of example a possible recirculating ink supply device 10 which can be part of an ink supply system described above for printing on articles, in particular containers, with ink.

The shown ink supply device 10 has an exemplary print head 8, as well as a pressurized feed tank 2, which can be coupled via the exemplary conduit 6 to an input of the print head 8 for supplying ink to the print head.

Likewise, the illustrated ink supply device 10 has a pressurized return tank 3, which may be coupled to an output of the print head via the conduit 7, to remove ink not consumed by the print head.

Optionally, the feed tank 2 and the return tank 3 may be accommodated in a housing 1.

The feed tank 2 and the return tank 3 can have separate covers or a common cover. For example, the cover of the housing 1 can cover both the feed tank 2 and the return tank 3.

In the example shown, the feed tank 2 is filled with ink 2a up to the ink level 2c and the gas volume 2b of the feed tank is under a pressure that can be provided by a central feed pressure unit (not shown).

For this purpose, the feed tank 2 can be connected or coupled via the exemplary conduit 4 to the central feed pressure unit (not shown).

Return tank 3 is, for example, filled with ink 3a up to ink level 3c, and the gas volume 3b of the return tank is under a pressure that can be provided by a central return pressure unit (not shown)

For this purpose, the return tank 3 can be connected or coupled via the exemplary conduit 5 to the central return pressure unit (not shown).

The return tank 3 can optionally also be connected via the exemplary conduit 9 to a refill system (not shown) for refilling ink into the ink supply device 10.

The possible refilling can be assisted or carried out by a possible exemplary pump 14. In addition, the possible refilling via the conduit 9 can optionally be regulated via a valve 13.

The ink in the refill line 9 can be at a slight overpressure, whereby the ink refilling can take place by opening the valve 13.

If, on the other hand, ink is to be removed from the return tank in order, for example, to lower the ink level or to avoid overflow of the return container when the ink supply goes down, this can be accomplished via the pump 14.

The return tank 3 is coupled by way of example to the feed tank 2 via the conduit 11, wherein the delivery of ink from the return tank 3 to the feed tank 2 can be carried out or can be assisted by a possible pump 11 a via the conduit 11.

If an exemplary change of the differential pressure between the feed and return flow is to take place, a change in the ink level 2c in the feed tank 2 carried out by the pump 11 a can take place, for example, wherein the corresponding setpoint level 3c in the return tank 3 is automatically adjusted, because the amount of ink in the system is constant.

If an exemplary change of the meniscus pressure is to take place, this can be achieved by an increase in the ink level 3c in the return tank 3 by opening the refill valve 13 and with (simultaneously) increasing the ink level 2c in the feed tank 2 by pump 11a.

Alternatively, a reduction of the ink level 3c in the return tank 3 by pump 14 and a (simultaneous) reduction of the ink level 2c in the feed tank 2 by pump 11 a can take place.

An ink filter 12 can optionally also be used in the conduit 11 between the return tank 3 and the feed tank 2.

In the exemplary conduit 7 for the return of ink from the print head outlet to the return tank 3, a purge valve 15 can optionally be arranged.

The ink supply device 10 can have numerous sensors. By way of example, ink level sensors 16, 17 for the feed tank 2 and return tank 3 are shown here, which can be designed, for example, as ultrasonic sensors and which can be arranged at the upper end of the tanks. The reference signs 16a, 17a indicate exemplary possible measuring beams (dashed lines) of the ink level sensors 16, 17.

Pressure sensors 20, 21 can also be arranged at the output/return or input/feed of the print head 8. Pressure sensors can also be arranged at other points, for example in the return tank 3 and/or in the feed tank 2.

In order to measure the pressure difference of the ink in the feed or in the return, the pressure prevailing in the print head, for example the plane of the print head nozzles, serves as a reference point. Therefore, the pressure sensors 20, 21 are arranged there accordingly.

Likewise, temperature sensors 22, 23 can be arranged at the output/return or input/feed of the print head 8. Temperature sensors can also be arranged at other points, for example in the return tank 3 and/or in the feed tank 2.

Stirrers 24, 25 can optionally be arranged in the return tank 3 and/or in the feed tank 2 and can be driven by means of motors 18, 19, for example.

As mentioned, the ink supply device 10 can have different heating means/heating elements.

By way of example, an optional heating element 28 is shown here and can be located in the vicinity of the side wall of the feed tank 2 for heating or temperature control of the ink in the feed tank 2.

It is also conceivable, for example, that heating element 28 can also be located in the feed tank 2 itself or in the side wall or in the bottom of the feed tank 2.

The reference sign 26 designates by way of example a digital controller which can generally be in communication with various, in particular all, components of the ink supply device 10 and the ink supply system to control the ink supply device 10 or the ink supply system.

Some exemplary communication connections of the controller 26 for transmitting data and control signals are indicated by dashed lines.

By way of example, an optional second controller 27 is also shown which can serve to control the print head 8. However, it is conceivable that the controller 26 can also take over the tasks of the controller 27, i.e., it is possible for the ink supply device 10 or the ink supply system with a plurality of ink supply device to be controlled solely by a single controller, for example the controller 26.

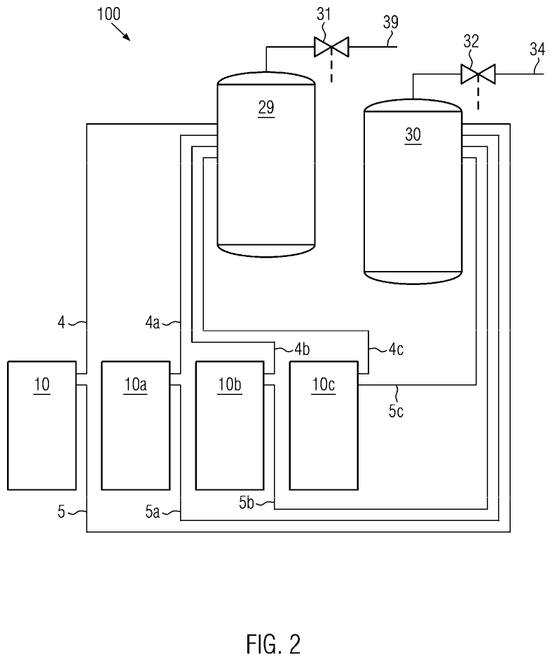

FIG. 2 is an example of an ink supply system 100 for use in a device for printing on articles, in particular containers, with ink.

The exemplary ink supply system 100 has an exemplary plurality, in particular four different, from recirculating ink supply devices 10, 10a, 10b and 10c.

The ink supply devices 10, 10a, 10b and 10c can be identical to or similar to the ink supply device 10 shown in FIG. 1.

In particular, the ink supply devices 10, 10a, 10b and 10c can be some or all of the components described in FIG. 1.

In particular, all ink supply devices 10, 10a, 10b and 10c can each have a feed tank and a return tank, wherein the respective feed tanks are each connected or coupled to a/the central feed pressure unit 29 and the respective return tanks are respectively connected or coupled to a/the central return pressure unit 30.

For example, the feed tank (not shown) of the ink supply devices 10 can be connected to the central feed pressure unit 29 via the conduit 4, the feed tank (not shown) of the ink supply device 10a can be connected to the central feed pressure unit 29 via the conduit 4a, the feed tank (not shown) of the ink supply device 10b can be connected to the central feed pressure unit 29 via the conduit 4b, and the feed tank (not shown) of the ink supply device 10c can be connected to the central feed pressure unit 29 via the conduit 4c.

Similarly, the return tank (not shown) of the ink supply devices 10 can be connected via the conduit 5 to the central return pressure unit 30, the return tank (not shown) of the ink supply device 10a can be connected via the conduit 5a to the central return pressure unit 30, the return tank (not shown) of the ink supply devices 10b can be connected via the conduit 5b to the central return pressure unit 30, and the return tank (not shown) of the ink supply device 10c can be connected via the conduit 5c to the central return pressure unit 30.

The central feed pressure unit 29 can thus apply pressure to the feed tanks of all ink supply devices 10, 10a, 10b and 10c and the central return pressure unit 30 can pressurize the return tanks of all ink supply devices 10, 10a, 10b and 10c.

Optionally and by way of example, reference sign 33 designates a conveying of supply pressure to the central feed pressure unit 29, which can also be controlled via a valve, for example a proportional valve 31.

Optionally and by way of example, reference sign 34 designates a conveying of supply pressure to the central return pressure unit 30, which can also be controlled via a valve, for example a proportional valve 32.

All components of the ink supply system 100, including the valves 31, 32 of the pressurized gas supply for the central feed pressure unit 29 and for the central return pressure unit 30, can be controlled by a single controller, for example by the controller 26 (not shown, or see FIG. 1) of the ink supply device 10.

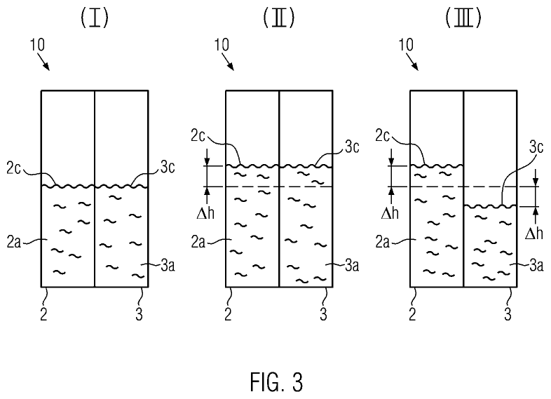

FIG. 3 shows, by way of example and schematically, three different possible scenarios (I), (II) and (III) for the ink level states in the feed tank 2 and return tank 3 of an ink supply device 10, wherein the ink supply device 10 can be identical or analogous to the ink supply devices of FIG. 2 or FIG. 1.

As described above, regulation of the meniscus pressure in the print head and regulation of the ink flow rate can take place via the regulation or the change in the ink level in the feed tanks and return tanks of the respective ink supply device.

The changes in ink shown by way of example in scenarios (I), (II) and (III) can be brought about, for example, as described above, via pumping or suction means.

In exemplary scenario (I), the ink level 2c of the ink 2a in the feed tank 2 is at the same height as the

ink level 3c of the ink 3a in the return tank 3. This same height can be regarded as an initial height.

In exemplary scenario (II), the ink level 2c of the ink 2a in the feed tank 2 is also at the same height as the ink level 3c of the ink 3a in the return tank 3. However, this same height is an amount Δh greater than the initial height in scenario (I).

This change in ink level may, as described above, result in a change in the meniscus pressure in the print head (not shown) of the ink supply device 10.

In exemplary scenario (III), the ink level 2c of the ink 2a in the feed tank 2 was raised by an amount Δh relative to the initial height from scenario (I), while the ink level 3c of the ink 3a in the return tank 3 was lowered by the amount Δh with respect to the initial height from scenario (I).

As described above, this can cause a change in the differential pressure between the pressure in the feed tank 2 or the pressure in the feed and the pressure in the return tank 3 or the pressure in the return flow.

By changing the differential pressure, an individual adaptation of the pressure or total pressure in the respective ink supply can be achieved, wherein the pressure or total pressure in the respective ink supply is composed of the gas pressure and the hydrostatic pressure in the respective ink supply. The constant pressure provided by the central pressure units 29, 30 does not change, however.

In this way, inter alia, the delivery rate or flow rate of ink can be regulated or controlled by the respective ink supply device.

For the calculation of the respective pressures mentioned, the following equations can be used, for example.

For example, the meniscus pressure P_{M} in the print head of an ink supply device can be determined as follows:

$${P}_{M} = ( \frac{{P}_{Ftot} - {P}_{Rtot}}{2} ) \cdot η$$

Here, P_{Ftot} is the total pressure prevailing in the feed, which is composed of:

P_{Ftot}=P_{V}_{ₒ}+P_{VH}+ΔP_{H},

wherein P_{V}_{ₒ} is the pressure provided or applied by the central feed pressure unit, P_{VH} is the hydrostatic pressure between the ink level in the feed tank and the print head, and ΔP_{H} designates a change of the hydrostatic pressure in the feed tank by an ink level change, and wherein η is an exemplary loss coefficient, wherein η can be e.g., between 0.8 and 1, and in which P_{Rtot} is the total pressure prevailing in the return, which is composed of:

P_{Rtot}=P_{R}_{ₒ}+P_{RH}+ΔP_{H},

wherein P_{R}_{ₒ} is the pressure provided or applied by the central backpressure unit, P_{RH} the hydrostatic pressure between the ink level in the return tank and the print head is, and ΔP_{H} designates a change of the hydrostatic pressure in the return tank due to an ink level change.

In this case, ΔP_{H} can be determined via

ΔP_{H}=δ·g·Δh,

wherein δ is the ink density, g is the gravitational acceleration, and Δh is a height change of the ink level.

The differential pressure P_{D}, i.e., the pressure difference between the feed and return of an ink supply device can be determined by

P_{D}=(P_{Ftot}−P_{Rtot})·η,

wherein P_{Ftot} is the aforementioned total pressure in the feed and P_{Rtot} is the aforementioned total pressure in the return, and η is the aforementioned loss coefficient.

If, for example in the initial scenario (I) for P_{Ftot} a value of 60 mbar is set, and for P_{Rtot} a value of −90 mbar is set, a pressure difference results between the feed and return of 150 mbar, and a meniscus pressure P_{M} of −15 mbar results in the print head.

By means of the exemplary increase in the ink level in the feed tank and in the return tank by the amount Δh in each case in comparison to the initial height of scenario (I), then, for example, a change of P_{Ftot} to 70 mbar and a change of P_{Rtot} to −80 mbar results, which leads to a changed meniscus pressure P_{M} in the print head of −5 mbar, while the pressure difference between the feed and return at 150 mbar remains the same.

If, according to scenario (III), the ink level 2c of the ink 2a in the feed tank 2 is raised by an amount Δh relative to the initial height from scenario (I), while the ink level 3c of the ink 3a in the return tank 3 is lowered by the amount Δh relative to the initial height from scenario (I), the meniscus pressure P_{M} relative to its value of −15 mbar remains unchanged from the initial scenario (I), but P_{Ftot} changes from 60 to 70 mbar, and P_{Rtot} from −90 to −100 mbar and thus in scenario (III) the differential pressure P_{D} changes from 150 mbar initial scenario (I) to 170 mbar in scenario (III).

The figures FIG. 1, FIG. 2 and FIG. 3 follow.

The reference signs are assigned as follows.

1 housing

2 feed tank

2a ink in the feed tank

2b gas volume in the feed tank

2c ink level in the feed tank

3 return tank

3a ink in the return tank

3b gas volume in the return tank

3c ink level in the return tank

4, 4a, 4b, 4c conveying/conduit/coupling from central feed pressure unit to the feed tank

5, 5a, 5b, 5c conveying/conduit/coupling from central return pressure unit to return tank

6 feed/ink line/conduit/coupling from feed tank to print head

7 return/ink line/conduit/coupling from return tank to print head

8 print head

9 inlet/conduit/coupling for ink refilling

10, 10a, 10b, 10c ink supply device

11 conduit/coupling from return tank to the feed tank

11a pump

12 ink filter

13 valve for ink refilling

14 pump for ink refilling

15 purge valve

16 ink level sensor for return tank

16a exemplary measurement beam

17 ink level sensor for feed tank

17a exemplary measurement beam

18 motor for stirrer in the feed tank

19 motor for stirrer in the return tank

20 pressure sensor for return to/at the print head

21 pressure sensor for feed from/at the print head

22 temperature sensor for ink temperature in the return

23 temperature sensor for ink temperature in the feed

24 stirrer for feed tank

25 stirrer for return tank

26 controller, digital controller, exemplary ink supply controller

27 controller, digital controller, exemplary print head controller

28 heating/heating means for tanks, in particular for feed tank

29 central feed pressure tank

30 central return pressure tank

31 valve, e.g., proportional valve

32 valve, e.g., proportional valve

33 conveying of supply pressure for the central feed pressure tank

34 conveying of supply pressure for central return pressure tank

100 ink supply system

1. An ink supply system for use in a device for printing on articles with ink, comprising:
one or more recirculating ink supply devices, each comprising:
at least one print head,
a pressurized feed tank coupled to an input of the print head for supplying ink to the print head,
a pressurized return tank coupled to an output of the print head for discharging ink not consumed by the print head,
wherein the return tank is coupled to the feed tank,
and wherein the ink supply system comprises a central feed pressure unit and a central return pressure unit,
and wherein at least one ink supply device is coupled to the central feed pressure unit and to the central return pressure unit such that the pressure in the feed tank of the at least one ink supply device is provided by the central feed pressure unit and the pressure in the return tank of the at least one ink supply device is provided by the central return pressure unit.

2. The ink supply system according to claim 1, comprising a plurality of recirculating ink supply devices, wherein the feed tanks of a plurality of the ink supply devices or the feed tanks of all ink supply devices are coupled to the central feed pressure unit, and wherein the central feed pressure unit in each case provides a pressure for the feed tanks of the ink supply devices coupled to the central feed pressure unit,
and/or
wherein the return tanks of a plurality of the ink supply devices or the return tanks of all ink supply devices are coupled to the central return pressure unit, and wherein the central return pressure unit in each case provides a pressure for the return tanks of the ink supply devices coupled to the central return pressure unit.

3. The ink supply system according to claim 2, wherein the volume of the central feed pressure unit is greater than the volume of the respective feed tanks of the ink supply devices that are coupled to the central feed pressure unit and/or
wherein the volume of the central return pressure unit is greater than the volume of the respective return tanks of the ink supply devices coupled to the central return pressure unit.

4. The ink supply system according to claim 1, wherein the ink supply devices further comprise means for regulating the height of the ink level in the feed tank and/or in the return tank of the respective ink supply device.

5. The ink supply system according to claim 4, wherein the ink supply devices further comprise heating means for heating the bottoms and/or the side walls of the feed tank and/or the return tank of the respective ink supply device.

6. The ink supply system according to claim 1, wherein the side walls of the feed tanks and/or of the return tanks of the respective ink supply device have a wall thickness of more than 2 mm or more than 10 mm or more than 20 mm.

7. The ink supply system according to claim 1, wherein the height of the side walls of the feed tanks and/or of the return tanks of the respective ink supply device is greater than the maximum extension of the bottom surface of the feed tanks and/or of the return tanks.

8. The ink supply system according to claim 1, wherein the ink supply devices each have an ink filter, wherein the ink filter is arranged between the return tank and the feed tank of the respective ink supply device.

9. The ink supply system according to claim 1, wherein the ink supply devices each have sensors for measuring the ink level in the respective return tanks and/or in the respective feed tanks, and/or wherein the ink supply devices each have sensors for measuring the temperature of the ink in the respective return tanks and/or in the respective feed tanks, and/or wherein the ink supply devices each have sensors for measuring the pressures in the respective return tanks and/or in the respective feed tanks and/or in or on the respective print heads.

10. The ink supply system according to claim 1, wherein the respective return tanks and/or the respective feed tanks of the ink supply devices have stirrers.

11. The ink supply system according to claim 1, further comprising a digital controller configured to control pressurization of the feed tanks via the central feed pressure unit and/or pressurization of the return tanks via the central return pressure unit,
and/or wherein digital controller is configured to control the means for regulating the height of the ink level in the feed tanks and/or in the return tanks of the ink supply devices.

12. A method for operating an ink supply system with one or more recirculating ink supply devices, wherein in the respective ink supply devices, ink is conveyed from a feed tank of the respective ink supply device to a print head of the respective ink supply device and at least partially from the print head to a return tank of the respective ink supply device,
wherein the conveying of the ink is caused by a gas pressure difference between a gas pressure in the feed tank and a gas pressure in the return tank,
and wherein the gas pressure in the feed tank of the respective ink supply device is provided by a central feed pressure unit and the gas pressure in the return tank of the respective ink supply device is provided by a central return pressure unit.

13. The method according to claim 12, wherein the central feed pressure unit provides a constant first gas pressure for the feed tanks of all ink supply devices, and the central return pressure unit provides a constant second gas pressure for the return tanks of all ink supply devices, the constant first gas pressure and the constant second gas pressure being different from one another.

14. The method according to claim 13, wherein a change in the meniscus pressure in the print head of the respective ink supply device is accomplished via an adjustment of the ink level in the feed tank and in the return tank of the respective ink supply device,
wherein an increase in the ink level in the feed tank and in the return tank causes a reduction of the meniscus pressure,
and wherein a reduction in the ink level in the feed tank and in the return tank causes an increase in the meniscus pressure.

15. The method according to claim 13, wherein the differential pressure of the ink between feed into the print head and return from the print head of the respective ink supply device is changed via an adjustment of the ink level in the feed tank and in the return tank of the respective ink supply device,
wherein the ink level in the feed tank is increased while the ink level in the return tank is reduced, or
wherein the ink level in the feed tank is reduced while the ink level in the return tank is increased.

16. The ink supply system of claim 1 wherein the article is a container.

17. The method of claim 12 wherein the method includes printing with the ink supply system onto a container.
